(19) United States
(12) Patent Application Publication
(10) Pub. No.: US 2014/0322449 A1
(43) Pub. Date: Oct. 30, 2014

(54) Photoresist Coating Device and Coating Method Thereof

(71) Applicant: Shenzhen China Star Optoelectronics Technology Co. Ltd., Shenzhen, Guangdong (CN)

(72) Inventors: Bin Xu, Shenzhen City (CN); Chih-Sheng Ko, Shenzhen City (CN)

(73) Assignee: Shenzhen China Star Optoelectronics Technology Co., Ltd., Shenzhen, Guangdong (CN)

(21) Appl. No.: 13/981,343

(22) PCT Filed: Jun. 24, 2013
(86) PCT No.: PCT/CN13/77769

§ 371 Date: Jul. 24, 2013

(30) Foreign Application Priority Data
Apr. 25, 2013 (CN) 201310147362.9

(51) Int. Cl. B05B 1/04; B05D 5/06; B05D 1/02

(52) U.S. Cl. CPC B05B 1/044; B05D 1/02; B05D 5/06
USPC 427/421.1; 239/589

(57) ABSTRACT

The present invention provides a photoresist coating device and the coating method thereof. Wherein, the photoresist coating device comprises a nozzle, the nozzle comprising a first nozzle split and a second nozzle split provided oppositely and a top plate used to fix the first nozzle split and the second nozzle split, a slit being formed between the first nozzle split and the second nozzle split, the middle of the operation face of the first nozzle split being provided with a first photoresist injection pipe, the first photoresist injection pipe being through the first nozzle split and connected with the slit, the top of the operation face of the first nozzle split being further provided with two second photoresist injection pipes which are on both sides of the first photoresist injection pipe, the second photoresist injection pipes being through the first nozzle split and connected with the slit. By providing the second photoresist injection pipe, it increases the amount of the injected photoresist from both sides of the slit, which remains broadly consistent in the amount of the injected photoresist, so that the uniformity of photoresist coating on the substrate can be ensured, and the coating quality will be improved.

This application claims priority to Chinese Patent Application Serial No. 201310147362.9, named as “photoresist coating device and coating method thereof”, filed on Apr. 25, 2013, the specification of which is incorporated herein by reference.

### BACKGROUND OF THE INVENTION

1. Field of the Invention

The present invention relates to the field of LCD production, and in particular to a photoresist coating device and coating method thereof.

2. The Related Arts

In the production of LCD, it needs to coat photoresist on the glass substrate with a certain thickness using photoresist coating device. Referring to FIGS. 1 and 2, the photoresist coating device according to the prior art comprises a nozzle 1′. The nozzle 1′ comprises a first nozzle split 11′ and a second nozzle split 12′ provided oppositely and a top plate 13′ used to fix the first nozzle split 11′ and the second nozzle split 12′. A slit 10′ is formed between the first nozzle split 11′ and the second nozzle split 12′. The bottom of the slit 10′ is a photoresist outlet 100′ (the shaded area as shown in FIG. 2 is photoresist). The bottoms of the first nozzle split 11′ and the second nozzle split 12′ form as cone. The middle of the operation face 111′ of the first nozzle split 11′ is provided with a photoresist injection pipe 112′. The top of the photoresist injection pipe 112′ is provided with a bubble discharge pipe 113′. Moreover, the both sides of the operation face 111′ are provided with the bubble discharge pipes 113′ respectively. The bubble discharge pipe 113′ is used to discharge the bubbles which may be generated during the injection of the photoresist. The photoresist injection pipe 112′ and the bubble discharge pipe 113′ are through the first nozzle split 11′ and connected with the slit 10′. The connected part between the photoresist injection pipe 112′ and the slit 10′ is provided with a chamber 110′. The bubble discharge pipe 113′ provided at the middle of the first photoresist injection pipe 11′ is connected with the chamber 110′.

Referring to FIG. 3, it shows a schematic view illustrating the flow condition of the photoresist at the slit 10′ when coating photoresist. The flow direction of the photoresist is shown as the arrow. When coating, the photoresist is injected from a photoresist injection pump through the photoresist injection pipe 112′. In the initial coating step, the photoresist injection pump is under acceleration state, the flow rate of the photoresist forced by the pump is also under acceleration state. The pressure near the photoresist injection pipe 112′ is larger, so the photoresist will flow to both sides. The photoresist injection area will be full of the photoresist and distribute as cone-shape. A photoresist penetration area is located at the bottom of the slit 10′. The photoresist is output from the photoresist outlet 100′ and coated on the substrate.

The drawback of the photoresist coating device and coating method thereof mentioned above is as follows. The pressure near the photoresist injection pipe 112′ is larger due to injecting photoresist in the middle, so that the amount of the output photoresist through the photoresist injection area (ex. output from the surrounding of the C position as shown in FIG. 1 and FIG. 3) is larger. The pressure at the both sides is smaller due to pressure difference, so that the amount of the output photoresist through the photoresist injection area (ex. output from the surrounding of the A position and B position as shown in FIG. 1 and FIG. 3) is smaller. Therefore, the uniformity of photoresist coating on the substrate is poor, which decreases the coating quality.

### SUMMARY OF THE INVENTION

The technical issue to be solved by the present invention is to provide a photoresist coating device and the coating method thereof, which can improve the uniformity and the quality of photoresist coating.

In order to solve the technical issue, the present invention provides a photoresist coating device, comprising: a nozzle, the nozzle comprising a first nozzle split and a second nozzle split provided oppositely and a top plate used to fix the first nozzle split and the second nozzle split, a slit being formed between the first nozzle split and the second nozzle split, the middle of the operation face of the first nozzle split being provided with a first photoresist injection pipe, the first photoresist injection pipe being through the first nozzle split and connected with the slit, the top of the operation face of the first nozzle split being further provided with two second photoresist injection pipes which are on both sides of the first photoresist injection pipe, the second photoresist injection pipes being through the first nozzle split and connected with the slit.

Wherein, the diameter of the second photoresist injection pipe is smaller than that of the first photoresist injection pipe.

Wherein, the second photoresist injection pipe is provided with a control valve, which is used to control the flow of the photoresist inside the second photoresist injection pipe.

Wherein, the first photoresist injection pipe and the second photoresist injection pipe are both connected to a photoresist injection pump.

Wherein, the top of the first photoresist injection pipe and the second photoresist injection pipe are both provided with a bubble discharge pipe used to discharge the bubbles.

Wherein, the connected part between the first photoresist injection pipe and the slit is provided with a first chamber; the bubble discharge pipe provided on the top of the first photoresist injection pipe is through the first nozzle split and connected with the first chamber.

Wherein, the connected part between the second photoresist injection pipe and the slit is provided with a second chamber; the bubble discharge pipe provided on the top of the second photoresist injection pipe is through the first nozzle split and connected with the second chamber.

The present invention further provides a coating method of photoresist coating device, the photoresist coating device comprising a nozzle, the nozzle comprising a first nozzle split and a second nozzle split provided oppositely and a top plate used to fix the first nozzle split and the second nozzle split, a slit being formed between the first nozzle split and the second nozzle split, the middle of the operation face of the first nozzle split being provided with a first photoresist injection pipe, the first photoresist injection pipe being through the first nozzle split and connected with the slit; the top of the operation face of the first nozzle split being further provided with two second photoresist injection pipes which are on both sides of the first photoresist injection pipe, the second photoresist injection pipes being through the first nozzle split and connected with the slit; the first photoresist injection pipe and the second photoresist injection pipe being both connected to a photoresist injection pump; the second photoresist injection pipe being provided with a control valve, which is used to control the flow of the photoresist inside the second photoresist injection pipe; the coating method comprising: during the acceleration state of the photoresist injection pump, injecting photoresist into the slit through the first photoresist injection pipe and the second photoresist injection pipe at the same time; during the steady state of the photoresist injection pump, gradually closing the control valve on the second photoresist injection pipe until the control valve is fully closed; during the deceleration state of the photoresist injection pump, closing the control valve.

Wherein, in the acceleration state of the photoresist injection pump, control the flow of the photoresist inside the second photoresist injection pipe, so that the amount of injected photoresist through the second photoresist injection pipe is less than that through the first photoresist injection pipe.

The present invention further provides a photoresist coating device, comprising: a nozzle, the nozzle comprising a first nozzle split and a second nozzle split provided oppositely and a top plate used to fix the first nozzle split and the second nozzle split, a slit being formed between the first nozzle split and the second nozzle split, the middle of the operation face of the first nozzle split being provided with a first photoresist injection pipe, the first photoresist injection pipe being through the first nozzle split and connected with the slit, the top of the operation face of the first nozzle split being further provided with two second photoresist injection pipes which are on both sides of the first photoresist injection pipe, the second photoresist injection pipes being through the first nozzle split and connected with the slit, the diameter of the second photoresist injection pipe being smaller than that of the first photoresist injection pipe.

The present invention provides a photoresist coating device and coating method thereof. By additionally providing the second photoresist injection pipe, it increases the amount of the injected photoresist at the both sides of the slit, which offsets the large difference of the amount of the injected photoresist resulted from the pressure difference between the middle and the both sides. Therefore, the amount of the output photoresist from the photoresist penetration area through the photoresist outlet is consistent at the middle and the both sides, so that the uniformity of photoresist coating on the substrate can be ensured, and the coating quality will be improved.

### BRIEF DESCRIPTION OF THE DRAWINGS

To illustrate clearly the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort.

FIG. 1 is a schematic perspective structure of the photoresist coating device according to the prior art;

FIG. 2 is a schematic cross-sectional view of the middle of the photoresist coating device according to the prior art;

FIG. 3 is a schematic view illustrating the flow condition of the photoresist at the slit 10′ when coating photoresist using the photoresist coating device according to the prior art;

FIG. 4 is a schematic perspective structure of the photoresist coating device according to the first embodiment of the present invention;

FIG. 5 is a schematic cross-sectional view of the middle of the photoresist coating device according to the first embodiment of the present invention;

FIG. 6 is a schematic cross-sectional view of the both sides of the photoresist coating device according to the first embodiment of the present invention;

FIG. 7 is a schematic view illustrating the flow condition of the photoresist at the slit 10′ when coating photoresist using the photoresist coating device according to the first embodiment of the present invention;

FIG. 8 is a schematic comparison of the amount of the output photoresist between the photoresist coating device according to the first embodiment of the present invention and the photoresist coating device according to the prior art during the acceleration state;

FIG. 9 is an opening timing diagram of the control valve of the photoresist coating device according to the first embodiment of the present invention; and

FIG. 10 is a flow diagram of the coating method of the photoresist coating device according to the second embodiment of the present invention.

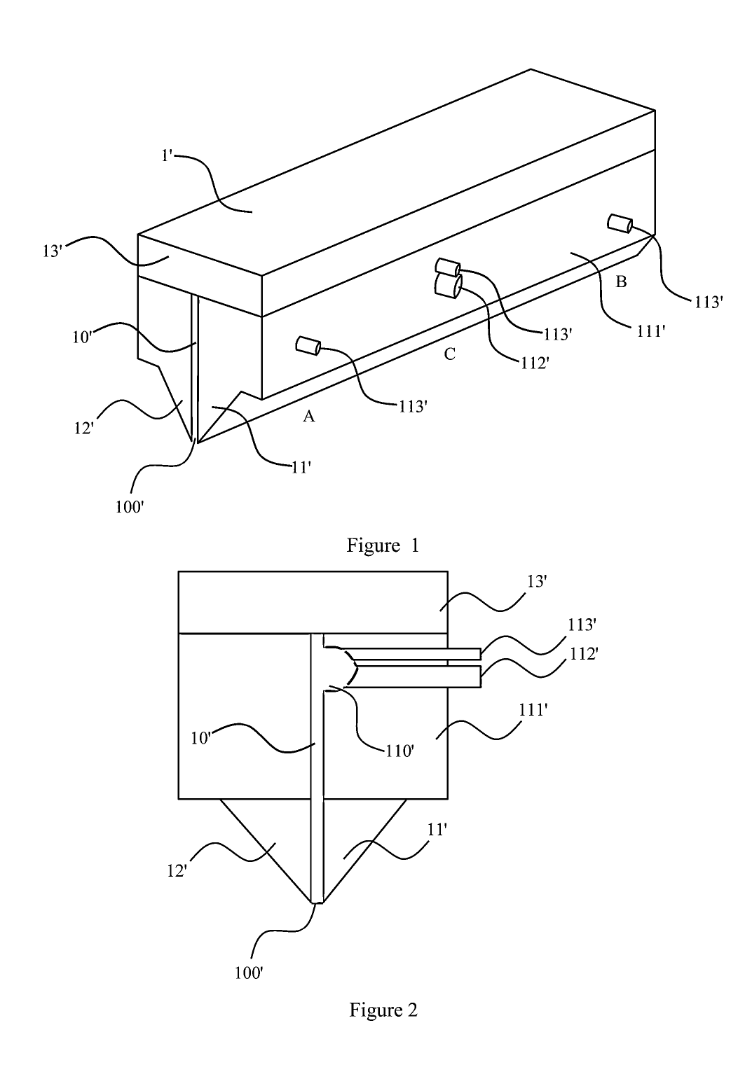

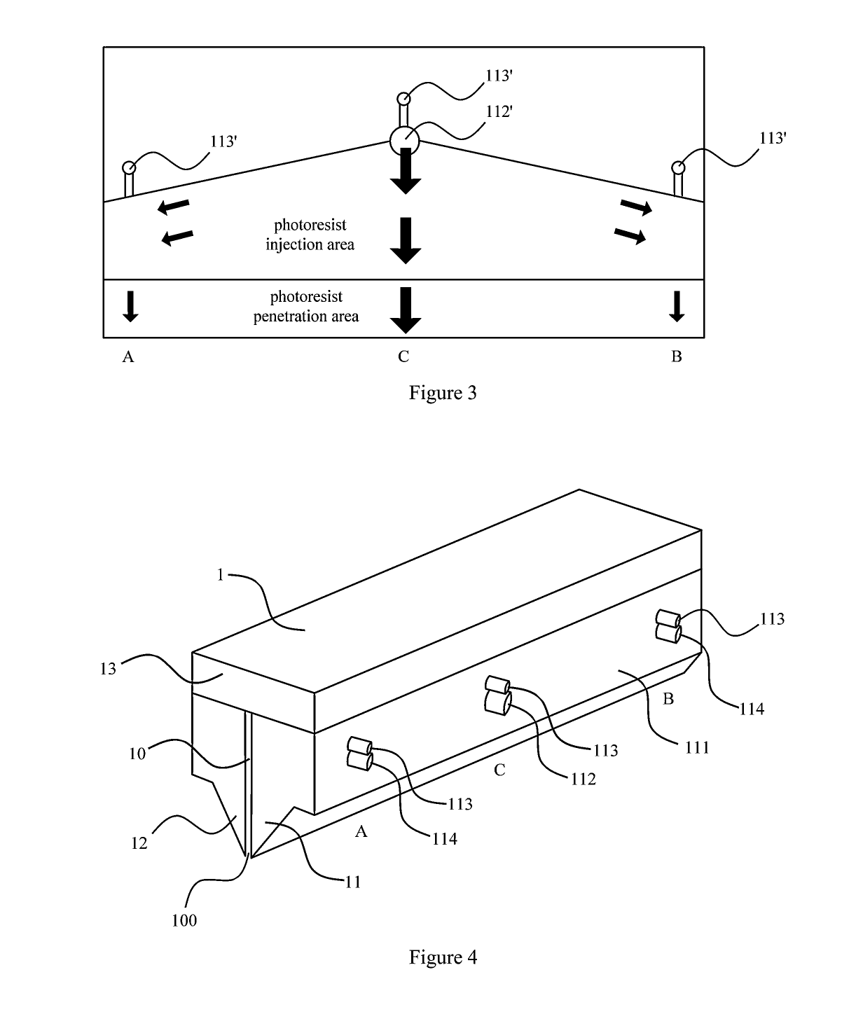

### DETAILED DESCRIPTION OF THE PREFERRED EMBODIMENTS

The accompanying drawings and the following detailed descriptions are the preferred embodiments of the present invention.

Referring to FIG. 4, the present invention provides a photoresist coating device, comprising: a nozzle 1. The nozzle 1 comprises a first nozzle split 11 and a second nozzle split 12 provided oppositely and a top plate 13 used to fix the first nozzle split 11 and the second nozzle split 12. A slit 10 is formed between the first nozzle split 11 and the second nozzle split 12. The bottom of the slit 10 is a photoresist outlet 100. The bottoms of the first nozzle split 11 and the second nozzle split 12 form as cone. The middle of the operation face 111 of the first nozzle split 11 is provided with a first photoresist injection pipe 112, and the top of the operation face 111 of the first nozzle split 11 is provided with two second photoresist injection pipes 114 which are on both sides of the first photoresist injection pipe 112. The top of the first photoresist injection pipe 112 and the second photoresist injection pipe 114 are both provided with a bubble discharge pipe 113 used to discharge the bubbles which may be generated during the injection of photoresist. The first photoresist injection pipe 112 and the second photoresist injection pipe 114 are both connected to a photoresist injection pump (not shown).

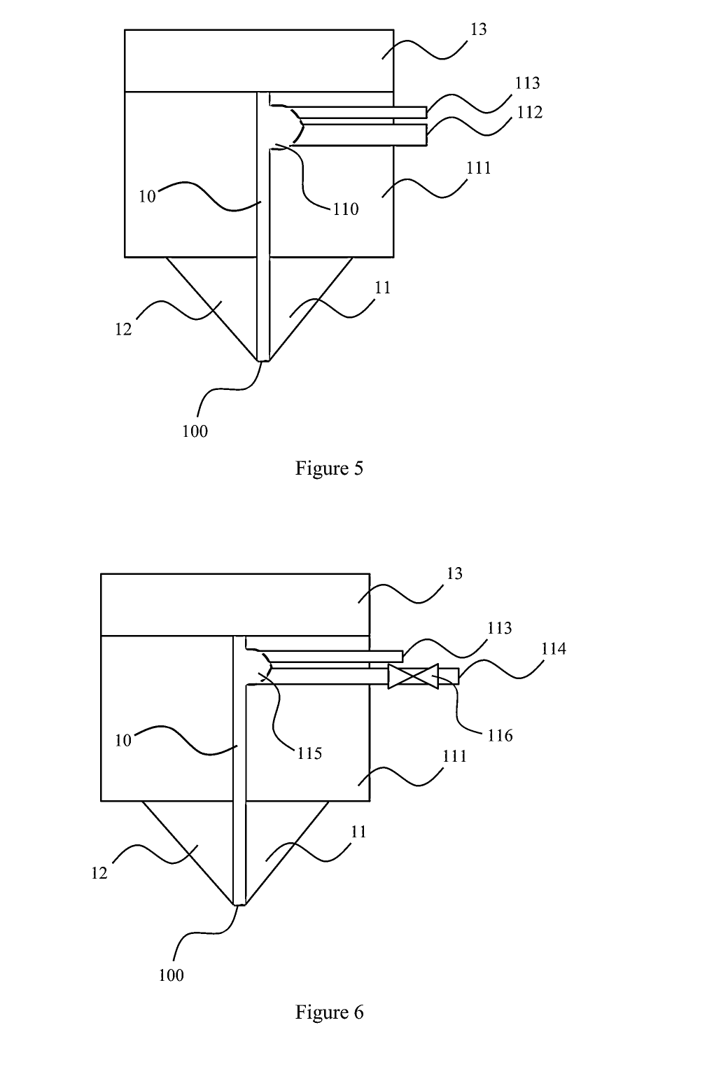

Referring to FIGS. 5 and 6, the first photoresist injection pipe 112 and the bubble discharge pipe 113 are through the first nozzle split 11 and connected with the slit 10. The connected part between the first photoresist injection pipe 112 and the slit 10 is provided with a first chamber 110. The bubble discharge pipe 113 provided on the top of the first photoresist injection pipe 112 is connected with the first chamber 110. The second photoresist injection pipe 114 and the bubble discharge pipe 113 are through the first nozzle split 11 and connected with the slit 10. The connected part between the second photoresist injection pipe 114 and the slit 10 is provided with a second chamber 115. The bubble discharge pipe 113 provided on the top of the second photoresist injection pipe 114 is also connected with the second chamber 115. The function of the first chamber 110 and the second chamber 115 is to provide storage space for the photoresist injected from the first photoresist injection pipe 112 and the second photoresist injection pipe 114. The shaded area as shown in FIGS. 5 and 6 is photoresist.

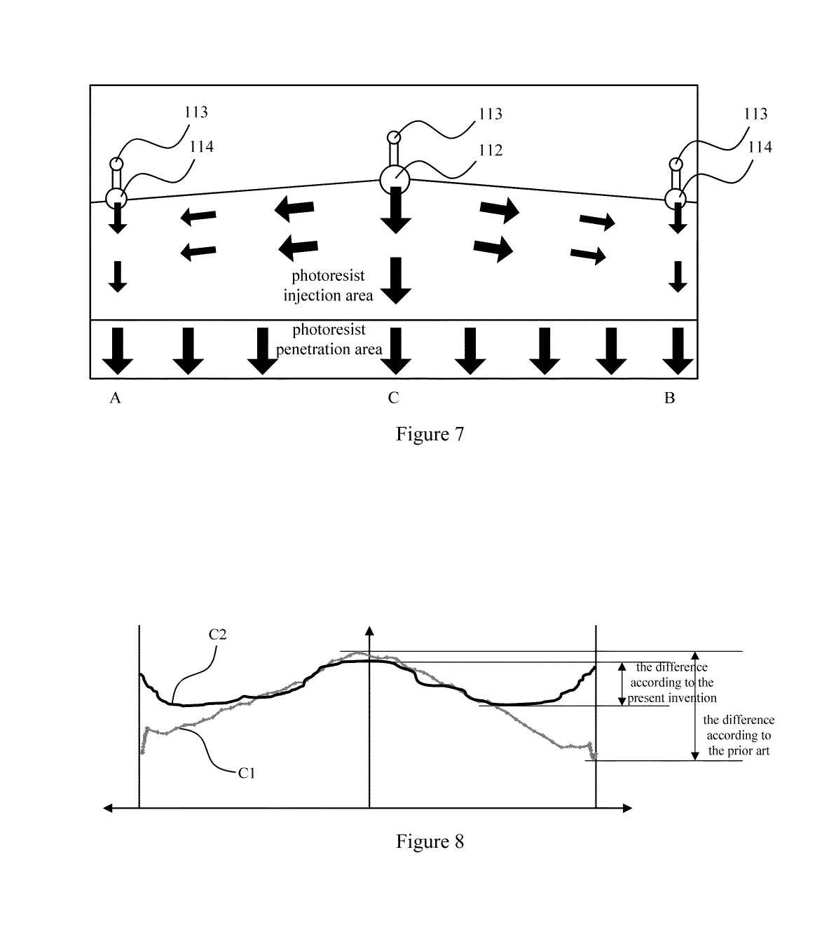

Referring to FIG. 7, it is a schematic view illustrating the flow condition of the photoresist at the slit 10′ when coating photoresist. When coating, the photoresist is injected from a photoresist injection pump through the first photoresist injection pipe 112. In the initial coating step, the photoresist injection pump is under acceleration state, the flow rate of the photoresist forced by the pump is also under acceleration state. The pressure near the first photoresist injection pipe 112 is larger, so the photoresist will flow to both sides from the middle of the slit 10 until the photoresist injection area is full of the photoresist. A photoresist penetration area is located at the bottom of the slit 10′. According to the description of the prior art mentioned above, if the photoresist is only injected at the middle, the pressure at the both sides is smaller due to pressure difference, so that the amount of the output photoresist at the both sides of the slit is smaller, which affects the uniformity of the coating. Therefore, one of the improvements of this embodiment is to additionally provide the second photoresist injection pipes 114 at the both sides. In the initial coating step, the photoresist is also injected through the second photoresist injection pipes 114 to the both sides of the slit 10. The advantages of additionally providing the second photoresist injection pipes 114 is to increase the amount of the output photoresist at the both sides of the slit 10, which offsets the large difference of the amount of the injected photoresist resulted from the pressure difference between the middle and the both sides. Therefore, the amount of the output photoresist from the photoresist penetration area through the photoresist outlet 100 is consistent at the middle (C position as shown in FIG. 7) and the both sides (A position and B position as shown in FIG. 7), so that the uniformity of photoresist coating on the substrate can be ensured, and the coating quality will be improved.

In effect, referring to FIG. 8, light curve C1 shows the photoresist coating device according to the prior art under the acceleration state of the photoresist injection pump. From the distribution of the amount of the photoresist output from the photoresist penetration area, it can be seen that the amount of photoresist at the both sides is significantly lower than that at the middle. Dark curve C2 shows the photoresist coating device according to the embodiment of the present invention under the acceleration state of the photoresist injection pump. From the distribution of the amount of the photoresist output from the photoresist penetration area, it can be seen that the difference of the amount of photoresist is significantly decreased because of additionally providing the second photoresist injection pipes 114 which compensates the amount of the photoresist at the both sides.

The part of the photoresist injected to the both sides comes from the middle position. To achieve the same amount of the output photoresist from the middle position to the both sides, the amount of the photoresist injected from the second photoresist injection pipes 114 must smaller than that from the first photoresist injection pipe 112. Therefore, in the present invention, the diameter of the second photoresist injection pipe 114 is smaller than that of the first photoresist injection pipe 112.

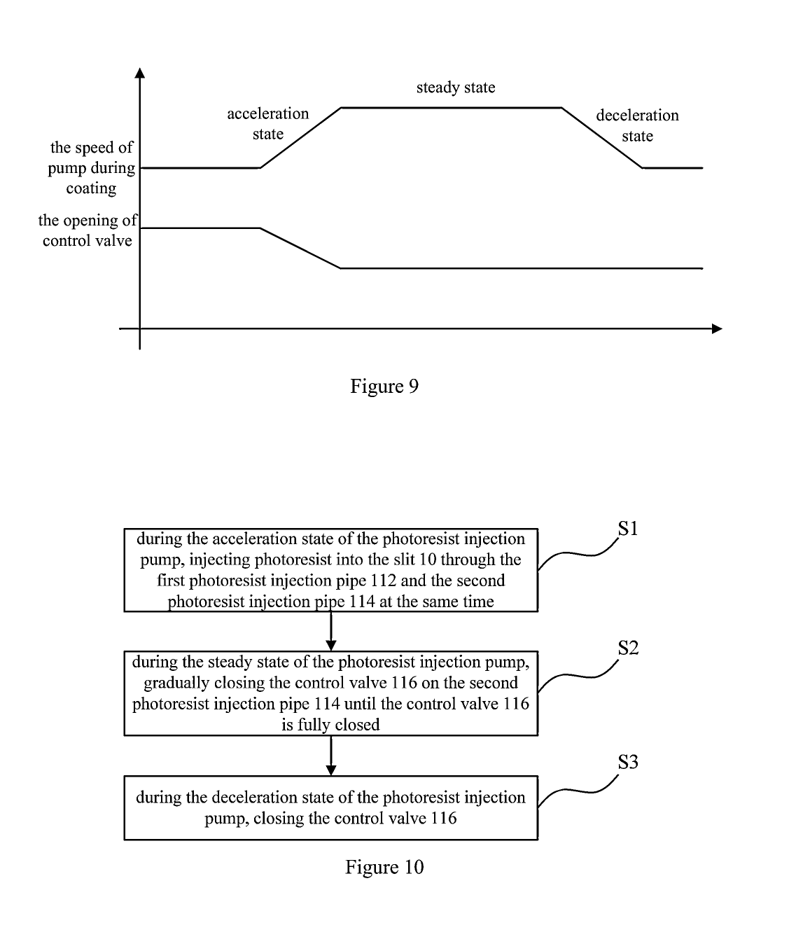

It is noted that the above description is for the photoresist injection pump under acceleration state during coating. Actually, after acceleration state, the photoresist injection pump enters the steady state, that is, maintain a constant speed. The photoresist also flows uniformly. There is no pressure difference between the middle position (C position as shown in FIG. 7) and the both sides (A position and B position as shown in FIG. 7), so the amount of the output photoresist has no different. Therefore, the amount of the photoresist injected into the middle position remains broadly consistent with the amount of the photoresist injected from the middle position to the both sides. It is not necessary to continuously compensate the amount of the injected photoresist of the both sides through the second photoresist injection pipes 114 which may cause excessive amount of the injected photoresist of the both sides, enlarge again the difference with the middle position, and affect the coating uniformity during steady state. When the photoresist injection pump enters the deceleration state, the flow of the photoresist decelerates. The surrounding of the middle position of the first photoresist injection pipe 112 is affected by larger force in the opposite direction of the flow direction. The both sides are affected by smaller force due to the pressure difference. The output photoresist at the both sides will be more than that at the middle position. In this circumstance, it is not necessary to compensate the amount of the injected photoresist of the both sides through the second photoresist injection pipes 114. It is divided in the working state of the photoresist injection pump. During acceleration state, it needs to compensate the amount of the injected photoresist of the both sides through the second photoresist injection pipes 114. During the steady and deceleration states, it is no longer necessary to compensate the amount of the injected photoresist of the both sides through the second photoresist injection pipes 114, and the second photoresist injection pipes 114 should be closed. Thus, the further improvement of the present embodiment is to provide a control valve 116 on the second photoresist injection pipes 114, which is used to control the flow of the photoresist inside the second photoresist injection pipe 114. The switching speed of the control valve 116 can be adjusted according to the actual requirements. Referring to FIG. 9, it is an opening timing diagram of the control valve according to the present embodiment. During the acceleration of the photoresist injection pump, open the control valve 116 and compensate the amount of the injected photoresist of the both sides through the second photoresist injection pipes 114. During the steady and deceleration states, the control valve 116 is closed gradually until it is completely closed, and it is no longer necessary to compensate the amount of the injected photoresist of the both sides through the second photoresist injection pipes 114. In this way, the amount of the output photoresist can be maintained balance and consistent during all working states of the photoresist injection pump.

Referring to FIG. 10, the second embodiment of the present invention provides a coating method of photoresist coating device. The photoresist coating device is the same as the first embodiment of the present invention and not repeated here. The coating method comprising:

step S1, during the acceleration state of the photoresist injection pump, injecting photoresist into the slit 10 through the first photoresist injection pipe 112 and the second photoresist injection pipe 114 at the same time;
step S2, during the steady state of the photoresist injection pump, gradually closing the control valve 116 on the second photoresist injection pipe 114 until the control valve 116 is fully closed;
step S3, during the deceleration state of the photoresist injection pump, closing the control valve 116.

As mentioned above, the part of the photoresist injected to the both sides comes from the middle position during the acceleration state of the photoresist injection pump. To achieve the same amount of the output photoresist from the middle position to the both sides, the step S101 further comprises: controlling the flow of the photoresist inside the second photoresist injection pipe 114, which allows the amount of the injected photoresist through the second photoresist injection pipe 114 smaller than that through the first photoresist injection pipe 112.

The present invention provides a photoresist coating device and coating method thereof. By additionally providing the second photoresist injection pipe, it increases the amount of the injected photoresist at the both sides of the slit, which offsets the large difference of the amount of the injected photoresist resulted from the pressure difference between the middle and the both sides. Therefore, the amount of the output photoresist from the photoresist penetration area through the photoresist outlet is consistent at the middle and the both sides, so that the uniformity of photoresist coating on the substrate can be ensured, and the coating quality will be improved.

The disclosed embodiments are the preferred embodiments of the present invention, but not intending to impose any unduly constraint to the appended claims. Any equivalent change is considered encompassed in the scope of protection defined by the claims of the present invention.

What is claimed is:

1. A photoresist coating device, comprising: a nozzle, the nozzle comprising a first nozzle split and a second nozzle split provided oppositely and a top plate used to fix the first nozzle split and the second nozzle split, a slit being formed between the first nozzle split and the second nozzle split, the middle of the operation face of the first nozzle split being provided with a first photoresist injection pipe, the first photoresist injection pipe being through the first nozzle split and connected with the slit, the top of the operation face of the first nozzle split being further provided with two second photoresist injection pipes which are on both sides of the first photoresist injection pipe, the second photoresist injection pipes being through the first nozzle split and connected with the slit.

2. The photoresist coating device as claimed in claim 1, wherein the diameter of the second photoresist injection pipe is smaller than that of the first photoresist injection pipe.

3. The photoresist coating device as claimed in claim 1, wherein the second photoresist injection pipe is provided with a control valve, which is used to control the flow of the photoresist inside the second photoresist injection pipe.

4. The photoresist coating device as claimed in claim 2, wherein the first photoresist injection pipe and the second photoresist injection pipe are both connected to a photoresist injection pump.

5. The photoresist coating device as claimed in claim 2, wherein the top of the first photoresist injection pipe and the second photoresist injection pipe are both provided with a bubble discharge pipe used to discharge the bubbles.

6. The photoresist coating device as claimed in claim 5, wherein the connected part between the first photoresist injection pipe and the slit is provided with a first chamber; the bubble discharge pipe provided on the top of the first photoresist injection pipe is through the first nozzle split and connected with the first chamber.

7. The photoresist coating device as claimed in claim 5, wherein the connected part between the second photoresist injection pipe and the slit is provided with a second chamber; the bubble discharge pipe provided on the top of the second photoresist injection pipe is through the first nozzle split and connected with the second chamber.

8. A coating method of photoresist coating device, the photoresist coating device comprising a nozzle, the nozzle comprising a first nozzle split and a second nozzle split provided oppositely and a top plate used to fix the first nozzle split and the second nozzle split, a slit being formed between the first nozzle split and the second nozzle split, the middle of the operation face of the first nozzle split being provided with a first photoresist injection pipe, the first photoresist injection pipe being through the first nozzle split and connected with the slit; the top of the operation face of the first nozzle split being further provided with two second photoresist injection pipes which are on both sides of the first photoresist injection pipe, the second photoresist injection pipes being through the first nozzle split and connected with the slit; the first photoresist injection pipe and the second photoresist injection pipe being both connected to a photoresist injection pump; the second photoresist injection pipe being provided with a control valve, which is used to control the flow of the photoresist inside the second photoresist injection pipe; the coating method comprising:
during the acceleration state of the photoresist injection pump, injecting photoresist into the slit through the first photoresist injection pipe and the second photoresist injection pipe at the same time;
during the steady state of the photoresist injection pump, gradually closing the control valve on the second photoresist injection pipe until the control valve is fully closed;
during the deceleration state of the photoresist injection pump, closing the control valve.

9. The coating method as claimed in claim 8, wherein, in the acceleration state of the photoresist injection pump, control the flow of the photoresist inside the second photoresist injection pipe, so that the amount of injected photoresist through the second photoresist injection pipe is less than that through the first photoresist injection pipe.

10. A photoresist coating device, comprising: a nozzle, the nozzle comprising a first nozzle split and a second nozzle split provided oppositely and a top plate used to fix the first nozzle split and the second nozzle split, a slit being formed between the first nozzle split and the second nozzle split, the middle of the operation face of the first nozzle split being provided with a first photoresist injection pipe, the first photoresist injection pipe being through the first nozzle split and connected with the slit, the top of the operation face of the first nozzle split being further provided with two second photoresist injection pipes which are on both sides of the first photoresist injection pipe, the second photoresist injection pipes being through the first nozzle split and connected with the slit, the diameter of the second photoresist injection pipe being smaller than that of the first photoresist injection pipe.
